(19) United States
(12) Patent Application Publication
(10) Pub. No.: US 2016/0218489 A1
(43) Pub. Date: Jul. 28, 2016

(54) IGNITER TIP WITH COOLING PASSAGE

(71) Applicant: General Electric Company, Schenectady, NY (US)

(72) Inventors: Richard Martin DiCintio, Simpsonville, SC (US); Patrick Benedict Melton, Horse Shoe, NC (US)

(21) Appl. No.: 15/088,426

(22) Filed: Apr. 1, 2016

Related U.S. Application Data
(62) Division of application No. 14/323,144, filed on Jul. 3, 2014.

(51) Int. Cl. H01T 21/02; B23K 26/342

(52) U.S. Cl. CPC H01T 21/02; B23K 26/342

(57) ABSTRACT

An igniter tip for a combustion system is provided. The igniter tip may include a central electrode; an insulator sleeve about the central electrode; and an outer electrode about the insulator sleeve, the outer electrode including a tubular wall having a cooling passage extending within the tubular wall, the cooling passage including an entrance opening and an exit opening to an exterior of the outer electrode. A combustion system may include the igniter tip.

### CROSS-REFERENCE TO RELATED APPLICATIONS

This application is a divisional of U.S. patent application Ser. No. 14/323,144 filed on Jul. 3, 2014, currently pending. The application identified above is incorporated herein by reference in its entirety for all that it contains in order to provide continuity of disclosure.

### BACKGROUND OF THE INVENTION

The disclosure relates generally to ignition systems, and more particularly, to an igniter tip with a cooling passage therein, a combustion system employing the igniter tip and an additive manufacturing file of the igniter tip.

Igniter tips are used in combustion systems such as gas turbines to ignite a fuel. One form of tip is extendable and retractable into a combustion chamber such that the igniter extends into the chamber for ignition and is retracted out of the chamber upon ignition by the combustion pressure. Current igniter tips are prone to bulge or melt due to high temperature exposure either through normal operation or due to the igniter not retracting as designed.

### BRIEF DESCRIPTION OF THE INVENTION

A first aspect of the disclosure provides an igniter tip for a combustion system, the igniter tip comprising: a central electrode; an insulator sleeve about the central electrode; and an outer electrode about the insulator sleeve, the outer electrode including a tubular wall having a cooling passage extending within the tubular wall, the cooling passage including an entrance opening and an exit opening to an exterior of the tubular wall.

A second aspect of the disclosure provides a combustion system comprising: a casing; a flow sleeve within the casing and surrounding a combustor liner; a source of a fuel-air mixture to the combustor liner; and an igniter including an igniter tip, the igniter tip including: a central electrode, an insulator sleeve about the central electrode, and an outer electrode about the insulator sleeve, the outer electrode including a tubular wall having a cooling passage extending within the tubular wall, the cooling passage including an entrance opening and an exit opening to an exterior of the tubular wall.

A third aspect of the disclosure provides a non-transitory computer readable storage medium storing code representative of an outer electrode for an igniter tip, the outer electrode physically generated upon execution of the code by a computerized additive manufacturing system, the code comprising: code representing the outer electrode, the outer electrode including: a tubular wall having a cooling passage extending within the tubular wall, the cooling passage including an entrance opening and an exit opening to an exterior of the tubular wall.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of a combustion system employing an igniter tip having a cooling passage according to embodiments of the disclosure.

FIG. 2 shows a cross-sectional view of an igniter including an igniter tip including an outer electrode having a cooling passage according to embodiments of the disclosure in an extended position.

FIG. 3 shows a cross-sectional view of an igniter tip including an outer electrode having the cooling passage.

FIG. 4 shows a cross-sectional view of an igniter tip including an outer electrode having the cooling passage according to one embodiment of the disclosure.

FIG. 5 shows a cross-sectional view of an igniter tip including an outer electrode having the cooling passage according to another embodiment of the disclosure in an extended position.

FIG. 6 shows a cross-sectional view of an igniter including an igniter tip including an outer electrode having the cooling passage according to embodiments of the disclosure in a retracted position.

FIG. 7 shows a cross-sectional view of an igniter including an igniter tip including an outer electrode having the cooling passage according to embodiments of the disclosure in a retracted position.

FIG. 8 shows a perspective view of the igniter tip of FIG. 6.

FIG. 9 shows a block diagram of an additive manufacturing process including a non-transitory computer readable storage medium storing code representative of an outer electrode for an igniter tip according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

The following description is directed to an igniter tip having an outer electrode with a cooling passage in a tubular wall thereof. The igniter tip will be described relative to a combustion system for a gas turbine engine. It will be understood, however, that the igniter tip may have applications other than a gas turbine engine. A combustion system including the igniter tip will also be described as will an additive manufacturing file usable to generate the outer electrode of the igniter tip.

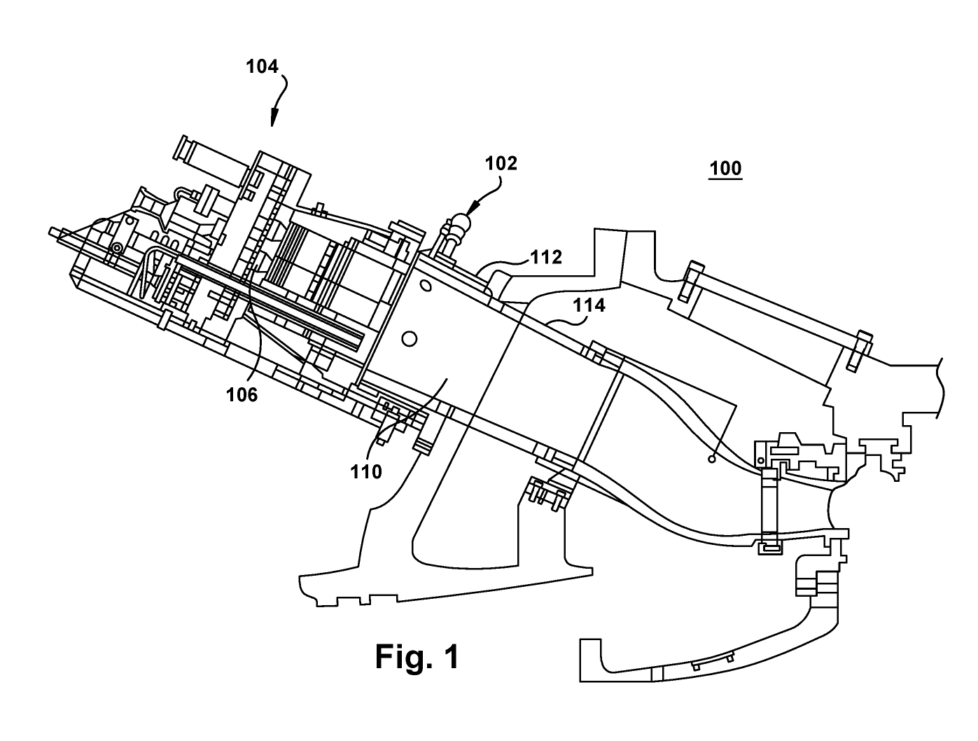

Now referring to the drawings, FIG. 1 is a schematic illustrating a combustion system 100 for a gas turbine engine. Combustion system 100 may be applied to applications other than a gas turbine engine. System 100 includes an igniter 102 incorporated into a combustor assembly 104 of the gas turbine engine (not shown). In accordance with one exemplary embodiment, igniter 102 is embodied as a spark plug. Igniter 102 in accordance with exemplary embodiments of the disclosure can be incorporated into a combustor assembly 104 with varying configurations and should not be limited to the configuration shown in FIG. 1.

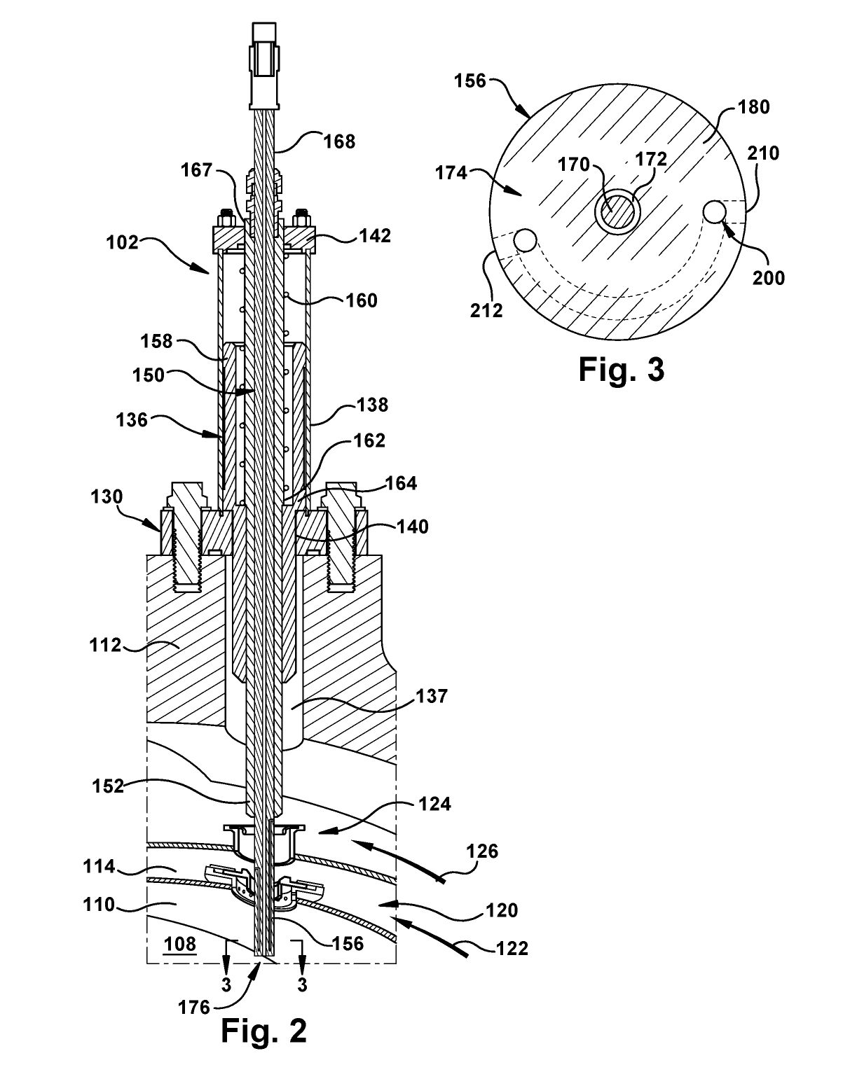

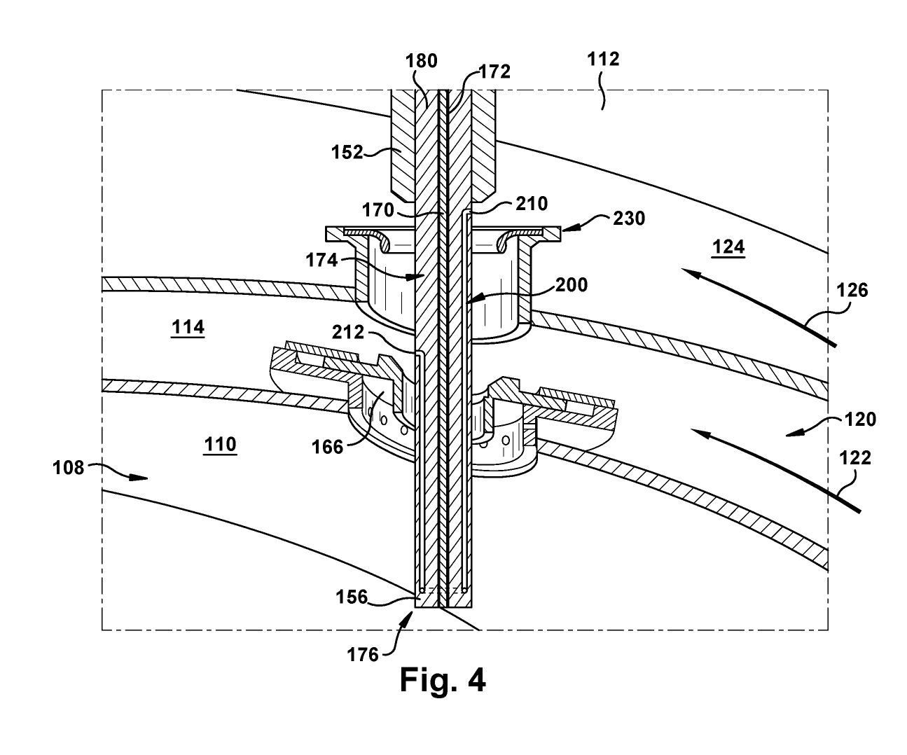

Referring to FIGS. 1 and 2, relevant portions of combustion system 100 relative to an example igniter 102 are illustrated. Combustion system 100 may include a combustor chamber 108 formed by a combustor liner 110 disposed within a compressor discharge casing 112 (hereinafter “casing”). A flow sleeve 114 may be mounted within casing 112 and surrounding combustor liner 110. As shown best in FIGS. 2 and 4, a space between flow sleeve 114 and combustor liner 110 forms a portion of a chamber or annulus 120 receiving a flow of cooling fluid 122 (e.g., air) from the compressor that enters through opening flow sleeve 114 and a transition piece impingement sleeve. In addition, a space between flow sleeve 114 and casing 112 forms a portion of a chamber or annulus 124 receiving a flow of cooling fluid 126 (e.g., air). Cooling fluid 126, 122 may include any now known or later developed fluid such as air. In one embodiment, cooling fluid 126 may be pressurized air from a compressor discharge (not shown), pressure P_{cd}. Fluid 126 may be, for example, at a temperature in the range of approximately 370-430° C., while combustion gases within combustor liner 110 may be, for example, at a temperature in the range of approximately 1480-1650° C. Fluid 122 may have a temperature somewhere between these two ranges.

As shown in FIG. 1, a source of a fuel-air mixture 106 to combustor liner 110 is provided. Source 106 may include, among other things, a fuel nozzle(s) (not numbered) that injects liquid or gaseous fuel into chamber 108 where it is burned with air, e.g., air channeled in annulus 120. As understood in the art, hot energetic exhaust flow of products of combustion, excess fuel and/or excess air move toward turbine blades (not shown) to produce the desired work in a known fashion.

As shown in FIG. 2, igniter 102 includes a mounting base 130 affixed rigidly to casing 112 by, for example, bolts or a peripheral weld. A seal (not shown) may be provided between facing surfaces of mounting base 130 and casing 112 to prevent air leakage therepast. A standoff cylinder 138 is affixed, at its lower end, in a hole 140 in mounting flange 130. A flange 142 is affixed to an outer end of standoff cylinder 138 to enclose an igniter assembly 136. Igniter assembly 136 of igniter 102 extends through a bore 137 within casing 112. Igniter assembly 136 may include a tubular sleeve 152 coaxial with an igniter tip 156 and a spring-loaded piston 158. Spring-loaded piston 158 includes a spring 160 compressible against flange 142 by piston 158. The components of igniter assembly 136 are collectively, coaxially, slidingly engaged relative to casing 112, mounting flange 130, standoff cylinder 138 and flange 142. Piston 158 may be made of a metal, and tubular sleeve 152 may be made of an insulator material to provide electrical insulation between igniter tip 156 and spring-loaded piston 158, e.g., a ceramic, polymer, or other insulator material capable of withstanding the thermal load of combustion system 100. Tubular sleeve 152 includes a shoulder 162 that engages with an interior of piston 158, and piston 158 includes a shoulder 164 that interacts with an edge of hole 140 in mounting base 130 in the extended position, shown in FIG. 2. A shoulder 167 of tubular sleeve 152 may engage with a connector end 168 of igniter tip 156. Various other structures may be employed for operatively coupling piston 158, igniter tip 156 and tubular sleeve 152.

Referring to FIG. 3, igniter tip 156 includes a central electrode 170; an insulator sleeve 172 about the central electrode; and an outer electrode 174 about the insulator sleeve. Outer electrode 174 includes a tubular wall 180 having a cooling passage 200 extending within the tubular wall. Cooling passage 200 can also be referred to as embedded in tubular wall 180 as it is an integral part thereof because it may be, as will be described herein, generated simultaneously with tubular wall 180 using additive manufacturing. As will be described herein, cooling passage 200 includes an entrance opening 210 and an exit opening 212 to an exterior of the tubular wall. It is emphasized that the dimensions shown in FIG. 3 are not to scale, and have been provided as such for clarity of description. A radial thickness of insulator sleeve 172 and tubular wall 180 may vary depending on the application. In one embodiment, the radial thickness of tubular wall 180 may be, for example, approximately 3.0-3.3 millimeters. An electrical connection is made to the end of electrodes 170, 174 at connector end 168 (FIG. 2) of igniter tip 156 adjacent flange 142 in a conventional manner so that an electrical charge may be conveyed to create a spark at an end 176 (FIG. 2) of igniter tip 156. Central electrode 170 may be made of a variety of conductive materials such as copper. Insulator sleeve 172 may be made of any variety of well known insulator materials such as a ceramic, graphite, etc., capable of withstanding the thermal load of combustion system 100. Although not shown, an igniter cap may be coupled to end 176. Igniter cap may be made of an Inco metal, or other suitable materials for combustion system applications

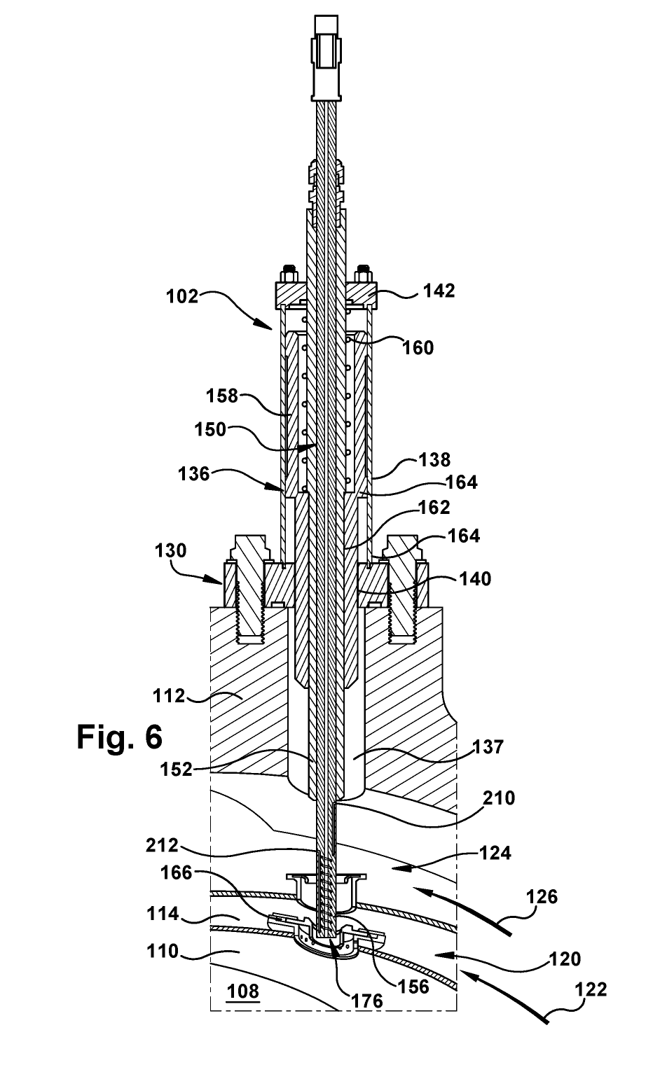

In the embodiments illustrated, igniter tip 156 is extendible to the position shown in FIGS. 2 and 4 and retractable to the position shown in FIG. 6. In other embodiments, igniter tip 156 may be stationary. In the extended position, as shown in FIG. 2, igniter tip 156 is extended into combustor chamber 108 by spring 160 applying pressure against piston 158. Piston 158 moves to engage mounting base 130 within standoff cylinder 138, and tubular sleeve 152 and igniter tip 156 move with it such that end 176 of igniter tip 156 extends into combustor liner 110. An electric charge is delivered via electrodes 170, 174 to cause a spark at end 176 of igniter tip 156 to cause ignition of the gas/fuel mixture within combustor chamber 108 when extended. Application of the electric charge may be controlled in a known fashion. Once combustion occurs, the pressure created by the combustion within combustor chamber 108 overcomes the pressure of spring 160 and causes igniter assembly 136 to retract such that end 176 of igniter tip 156 moves out of combustor liner 110 and into a sealing, recess housing 166 (FIG. 6) coupled thereto, thereby preventing damage to igniter tip 156. Any now known or later developed sealing, recessed housing 166 may be provided in combustor liner 110 (and flow sleeve 114) and to receive igniter tip 156.

In contrast to conventional igniter tips, as shown in FIGS. 3 and 4, tubular wall 180 includes a cooling passage 200 extending within tubular wall 180. Each cooling passage 200 may have a diameter of approximately 0.80-1.2 millimeters. Cooling passage 200 may take a variety of paths through tubular wall 180 of outer electrode 174 to provide cooling to any necessary portion of igniter tip 156. In one embodiment, cooling passage 200 includes an entrance opening 210 from an exterior of tubular wall 180 to cooling passage 200, and an exit opening 212 from cooling passage 200 to the exterior of tubular wall 180. In this fashion, a cooling fluid may enter from a particular location and exit at a different location, providing cooling fluid to a variety of positions.

Each opening 210, 212 may open to a particular chamber of combustion system 100 where each chamber has a different pressure therein, thus creating a cooling fluid flow through cooling passage 200. It is emphasized that while specific chambers and cooling passage flow paths within tubular wall will be described herein, a variety of chambers may be used and the cooling passage may take a variety of flow paths not explicitly described herein but considered within the scope of the disclosure. As will be apparent, FIGS. 2-8 show a small sampling of the possibilities.

Referring to FIG. 4, in an extended position of igniter tip 156, entrance opening 210 may open to chamber 124 of combustion system 100 positioned between flow sleeve 114 and casing 112 of the combustion system. As noted herein, chamber 124 may carry pressurized air flow 126 such as that from a compressor (not shown) discharge, having a pressure P_{cd} sufficient to enter entrance opening 210. In the FIG. 4 embodiment, in an extended position of the igniter tip, exit opening 212 may open to chamber 120 positioned between flow sleeve 114 and combustor liner 110 of the combustion system. Chamber 120 has a lower pressure than chamber 124, i.e., pressure P_{cd}, creating a cooling fluid flow from chamber 124 to chamber 120. As illustrated, between entrance opening 210 and exit opening 212, cooling passage 200 may pass through end 176 of igniter tip 156/tubular wall 180. Furthermore, between entrance opening 210 and exit opening 212, cooling passage 200 passes through a length of tubular wall 180, providing cooling to igniter tip 156. The length may be user defined depending on cooling requirements. In the example shown, cooling passage 200 passes from entrance opening 210 to end 176 of igniter tip 156 and then back to exit opening 212, cooling igniter tip 156 as the cooling fluid flows to tip 176 and then again as it flows away from tip 176. As shown best in phantom in FIG. 3, at end 176, cooling passage 200 may pass at least partially circumferentially within tubular wall 180 about central electrode 170 to cool end 176. The degree of the circumferential portion may be user defined. In this fashion, a cooling fluid flow from pressurized air flow 126 may enter igniter tip 156, act to cool portions of igniter tip 156 and then exit into chamber 120 to join cooling fluid flow 122. Since flow 122 is eventually used for combustion, this arrangement ensures that any cooling fluid used will be included at the point of the combustor where fuel is added, thus improving the overall efficiency of the system.

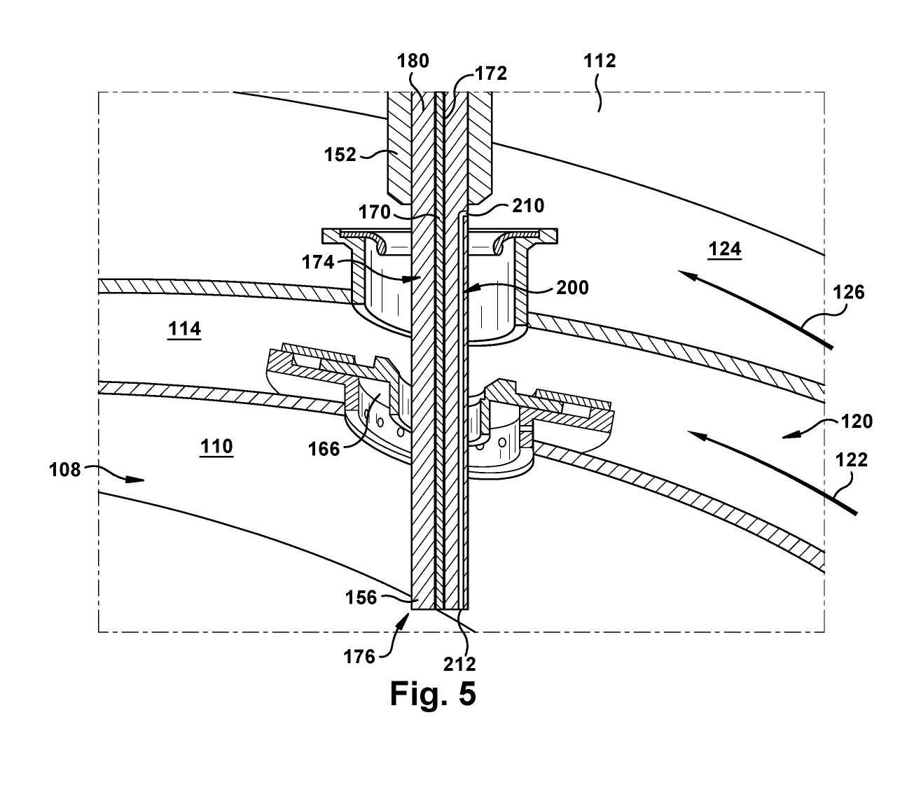

In another embodiment shown in FIG. 5, exit opening 212 opens to combustor chamber 108, i.e., at end 176, within combustor liner 110 of the combustion system in an extended position of the igniter tip. In this fashion, cooling fluid flow 126 can be delivered directly to combustor chamber 108 to provide cooling and/or air for the fuel/air combustion mixture.

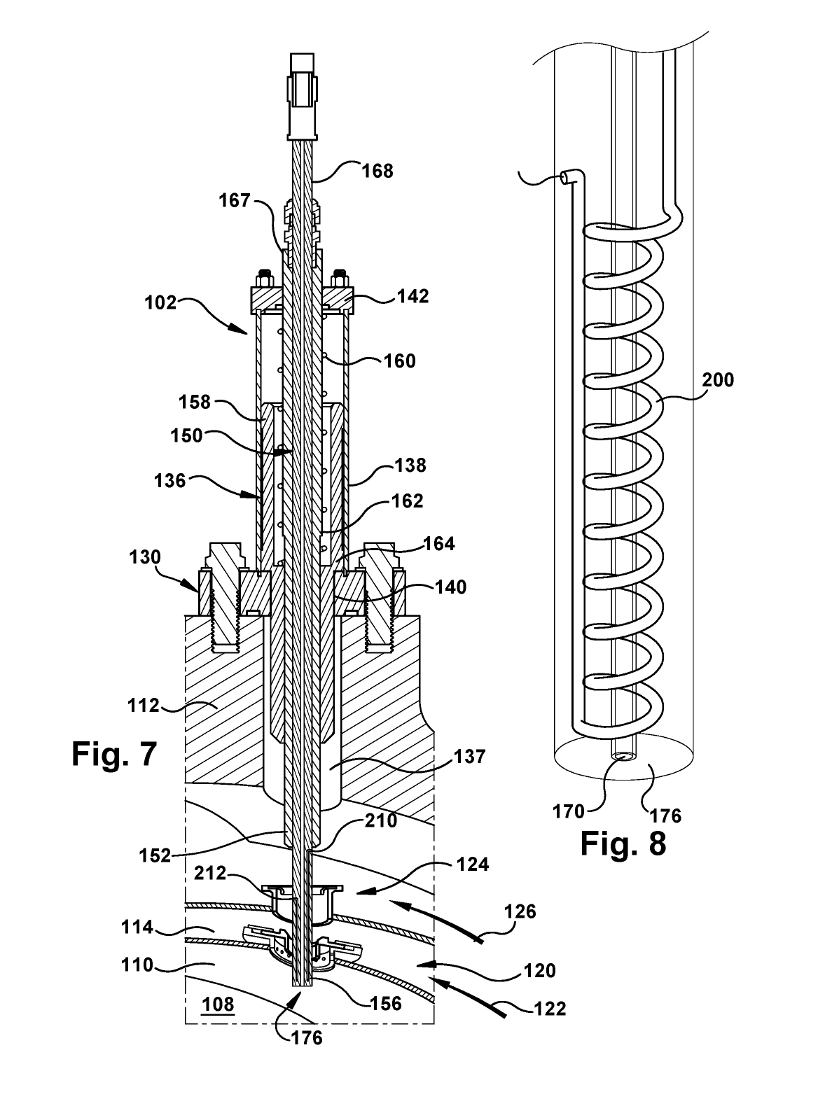

Referring to FIG. 6, a retracted position for an embodiment similar to that of FIG. 4 embodiment is illustrated. In this embodiment, in the retracted position of igniter tip 156, both entrance opening 210 and exit opening 212 open to the same chamber, preventing a cooling fluid flow through the cooling passage. In the FIG. 6 example, both openings 210, 212 are open to chamber 124; however, openings 210, 212 may be positioned to open to another chamber, e.g., 120. FIG. 7 shows another embodiment of a retracted position for an embodiment similar to that of FIG. 2, which shows igniter tip in an extended position. In this embodiment, in the retracted position of igniter tip 156, entrance opening 210 opens to chamber 124 and exit opening 212 opens to chamber 120, just as in the extended position. In this fashion, a cooling fluid flow continues regardless of whether igniter tip 156 is in the extended or retracted position. In any retracted position, end 176 of igniter tip 156 is in sealed, recessed housing 166 of combustor liner 110 for protection.

Although various embodiments illustrate straight paths for cooling passage 200 through tubular wall 190, it is understood that cooling passage may take any path desired. For example, as shown in FIG. 6 and in an enlarged perspective view in FIG. 8, cooling passage 200 may extend at least partially helically about central electrode 170. In other examples, the path may: circle around openings 210, 212, extend sinusoidally within igniter tip 156, and/or extend through a particular hot spot of igniter tip 156. Further, although not shown, cooling passage 200 may also extend outwardly in tubular wall 180, i.e., towards casing 112 from entrance opening 210, for at least part of its length. In any event, embodiments of the disclosure allow for tubular wall 180 and, hence, igniter tip 156, to be cooled while the igniter is in the extended (and/or retracted) position in order to improve the robustness of the igniter, and protect it should the igniter get stuck in the extended position. Cooling passage 200 may extend the life of igniter tip 156, limit or prevent damage that can occur when the igniter tip is extended longer than intended, and/or may allow for the continued use of current igniters at higher combustor temperatures.

The above-described igniter tip and parts thereof can be manufactured using any now known or later developed technologies, e.g., machining, casting, etc. In one embodiment, however, additive manufacturing is particularly suited for manufacturing outer electrode 174, i.e., tubular wall 180, and in particular, cooling passage 200 therein. As used herein, additive manufacturing (AM) may include any process of producing an object through the successive layering of material rather than the removal of material, which is the case with conventional processes. Additive manufacturing can create complex geometries without the use of any sort of tools, molds or fixtures, and with little or no waste material. Instead of machining components from solid billets of metal, much of which is cut away and discarded, the only material used in additive manufacturing is what is required to shape the part. Additive manufacturing processes may include but are not limited to: 3D printing, rapid prototyping (RP), direct digital manufacturing (DDM), selective laser melting (SLM) and direct metal laser melting (DMLM). In the current setting, DMLM has been found advantageous.

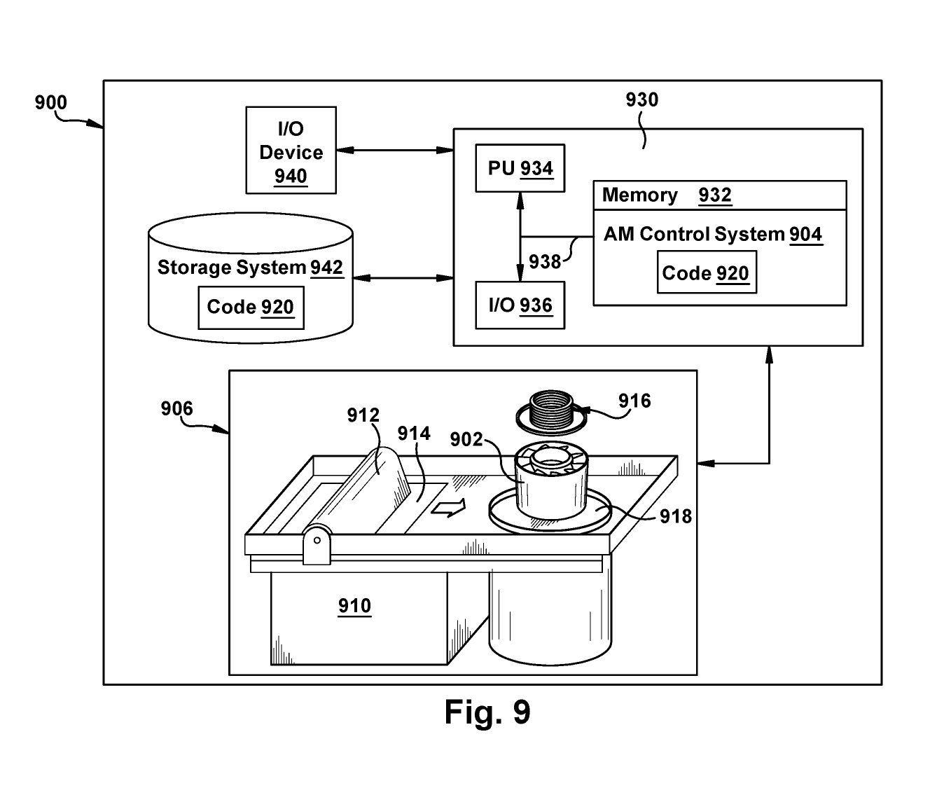

To illustrate an example additive manufacturing process, FIG. 9 shows a schematic/block view of an illustrative computerized additive manufacturing system 900 for generating an object 902. In this example, system 900 is arranged for DMLM. It is understood that the general teachings of the disclosure are equally applicable to other forms of additive manufacturing. Object 902 is illustrated as a double walled turbine element; however, it is understood that the additive manufacturing process can be readily adapted to manufacture outer electrode 174 (FIGS. 3-5). AM system 900 generally includes a computerized additive manufacturing (AM) control system 904 and an AM printer 906. AM system 900, as will be described, executes code 920 that includes a set of computer-executable instructions defining outer electrode 174 (FIGS. 3-5) to physically generate the object using AM printer 906. Each AM process may use different raw materials in the form of, for example, fine-grain powder, liquid (e.g., polymers), sheet, etc., a stock of which may be held in a chamber 910 of AM printer 906. In the instant case, outer electrode 174 (FIGS. 3-5) may be made of stainless steel or similar materials. As illustrated, an applicator 912 may create a thin layer of raw material 914 spread out as the blank canvas from which each successive slice of the final object will be created. In other cases, applicator 912 may directly apply or print the next layer onto a previous layer as defined by code 920, e.g., where the material is a polymer. In the example shown, a laser or electron beam 916 fuses particles for each slice, as defined by code 920. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of outer electrode 174 (FIGS. 3-5), described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 940 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of outer electrode 174 (FIGS. 3-5). As noted, code 920 includes a set of computer-executable instructions defining outer electrode that can be used to physically generate the tip, upon execution of the code by system 900. For example, code 920 may include a precisely defined 3D model of outer electrode and can be generated from any of a large variety of well known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing outer electrode 174 (FIGS. 3-5) into a series of thin slices that it assembles using AM printer 906 in successive layers of liquid, powder, sheet or other material. In the DMLM example, each layer is melted to the exact geometry defined by code 920 and fused to the preceding layer. Subsequently, the outer electrode may be exposed to any variety of finishing processes, e.g., minor machining, sealing, polishing, assembly to other part of the igniter tip, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A non-transitory computer readable storage medium storing code representative of an outer electrode for an igniter tip, the outer electrode physically generated upon execution of the code by a computerized additive manufacturing system, the code comprising:
code representing the outer electrode, the outer electrode including:
a tubular wall having a cooling passage extending within the tubular wall, the cooling passage including an entrance opening and an exit opening to an exterior of the tubular wall.

2. The storage medium of claim 1, wherein, between the entrance opening and the exit opening, the cooling passage passes through an end of the tubular wall.

3. The storage medium of claim 1, wherein, between the entrance opening and the exit opening, the cooling passage passes through a length of the tubular wall.

4. The storage medium of claim 1, wherein, between the entrance opening and the exit opening, a portion of the cooling passage passes through a length of the tubular wall in an at least partially helical manner.
